(19) United States
(12) Patent Application Publication
(10) Pub. No.: US 2011/0272257 A1
(43) Pub. Date: Nov. 10, 2011

(54) Rotation unit

(76) Inventor: Dmitry Borisovich Nikishichev, g. Moscow (RU)

(21) Appl. No.: 13/068,898

(22) Filed: May 23, 2011

Related U.S. Application Data
(63) Continuation-in-part of application No. PCT/RU2009/000673, filed on Dec. 7, 2009.

(30) Foreign Application Priority Data
Dec. 19, 2008 (RU) 2008150422
Sep. 24, 2010 (RU) 2010139297

(51) Int. Cl. B65G 39/10

(52) U.S. Cl. 198/842

(57) ABSTRACT

A device for transmitting rotational motion, which is used, for example, in belt conveyors operating in a dusty atmosphere in coal production, mining or construction, includes a cylindrical body mounted on a shaft in bearing assemblies with an inner space being formed between the internal surface of the body and the external surface of the shaft, is equipped with a bladder which is deformable under the action of a difference in pressure, is arranged in the inner space and communicates with the atmosphere. The bladder preferably communicates with the atmosphere via a duct provided in the shaft. The unit may be equipped with a protective perforated box in which the bladder is arranged. The design of the device prevents dust from dropping into the internal space thereof, thus reducing wear of the parts of the device and increasing the service life thereof.

### FIELD OF THE INVENTION

The claimed invention relates to a rotation unit that can be used as a part of belt conveyors operating in a dusty atmosphere, for example in underground mines, or in construction industry.

### BACKGROUND OF THE INVENTION

Well known construction of a roller is a dust-proof cylindrical body mounted to rotate around a shaft by bearing. The last are equipped by special seals to protect against particles of coals, rocks, building materials or any other abrasive dust present in the industrial atmosphere.

The sealing elements are usually designed as a pack of rings of flexible porous material of different density that contains a fluid lubricant (RU 2,278,069 C1, published on Jun. 20, 2006).

To protect the bearings, the inner space between the body of a belt conveyor roller and the friction unit could be filled with a composite material consisting of shavings of anti-friction self-lubricating material, viscous lubricant, and a solid lubricant (RU 2,238,901, published on Oct. 27, 2003).

This prior art inventions do not protect the bearings reliably against the abrasive effect of hard particles present in surrounding atmosphere.

The closest prior art related to the claimed invention is a rotation unit. That unit is a belt conveyor roller disclosed in RU 2,260,553 C2, published on Sep. 10, 2004. The above mentioned device is assembled as a cylindrical body mounted in bearings to rotate around a shaft and having an annular inner space defined by the internal walls of the body and the external wall of the shaft. The bearings have external seals. Chambers between the seals and the bearings are filled with an oil-impregnated porous material. Protection against abrasive dust penetrating from the atmosphere into the bearings of the conveyor rollers is provided as follows: in case a pressure difference occurs between the ambient atmosphere and the internal space of a roller, the dusty air penetrates trough the external seals into the chambers where the dust is captured by the oil-impregnated porous material.

The above invention does not provide reliable protection for bearings against abrasive dust of the ambient atmosphere, because it does not exclude pressure difference in the bearing assembly. This pressure difference force abrasive particles to move into the bearings, no matter what protection option is used.

All the above mentioned patents present partial solutions of the problem. They increase service life of a device by cleaning from dust the air, which enter the internal space of a roller caused by pressure difference.

### SUMMARY OF THE INVENTION

An object of the invention is to extend the service life of the device by eliminating the cause of dusty air penetration into the internal space of the body.

This object is achieved by providing a rotation unit comprising a body mounted in bearings on a shaft to form an inner space between the internal surface of the body and the external surface of the shaft, wherein the rotation unit is provided with a flexible bladder deformable under the effect of difference of pressures, said bladder being installed within said inner space and communicating with the atmosphere.

Said bladder is preferably connected with the atmosphere through a channel made in the shaft.

Said rotation unit is preferably provided with a perforated box in which said bladder is located.

In a preferred variant of the rotation unit the flexible bladder has the form of a sleeve embracing the shaft so that the two opposite edges thereof are fixed hermetically on said shaft.

The edges of the sleeve fixed on the spindle preferably have annular folds.

The bladder can change its volume because it is flexible. Therefore, the volume of the inner space of the body can change itself freely. So, it makes pressure within the inner space of the claimed device body always equal to the outer atmospheric pressure regardless of temperature changes. The pressures parity inside and outside of the body excludes the reason of dusty air penetration into inner space of the device body. Therefore, abrasive dust would not be drawn into the bearings. As a result, the service life of the device increases.

### DESCRIPTION OF THE DRAWINGS

The invention is described with reference to the following drawings:

FIG. 1 shows a longitudinal sectional view of the roller device;

FIG. 2 shows a cross-sectional view of the hollow shaft;

FIG. 3 shows a longitudinal sectional view of the preferred variant;

FIG. 4 shows a isometric view of the preferred variant of the roller device.

### EMBODIMENTS OF THE INVENTION

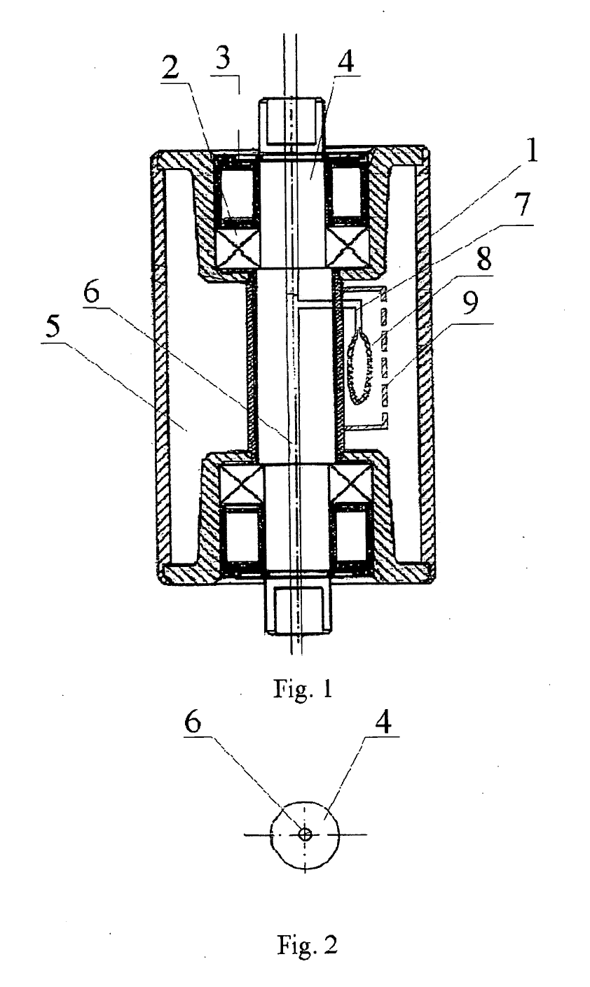

One of the possible embodiments of the claimed rotation unit is disclosed below. The rotation unit (FIG. 1 and FIG. 2) includes a cylindrical body 1 mounted by means of bearings 2 and labyrinth seals 3 on a shaft 4 forming annular inner space 5. A channel 6 opening into the atmosphere is arranged within the shaft 4 and extends along its length. An L-shaped pipe 7 has one of its ends tightly connected to the channel 6, and the other end thereof is tightly closed by the bladder 8. It has inner space and is made in as a flexible diaphragm. A section of the pipe 7 and the bladder 8 is protected by a perforated box 9 fixed at the shaft 4.

In case of the rotation unit is used as a roller of a belt conveyor, it operates as follows:

If the conveyor or roll table is turned on by the operator, the cylindrical body 1 rotates around the shaft 4. Rotation causes the temperature to rise in the inner space 5. If the unconfined volume of the inner space 5 remains unchanged, than pressure is to rise in the inner space 5. However, this does not happen because rising pressure causes the bladder 8 to contract and exhaust air from its inner space through the pipe 7 and the channel 6 into the atmosphere. In this case the unconfined volume of the inner space 5 extends. As a result, pressure in the inner space 5 is maintained equal to atmospheric pressure.

If the conveyor or roll table is turned off by the operator, the body 1 stops to rotate. The temperature in the inner space 5 decreases. If the unconfined volume of the inner space 5 remained unchanged, the pressure goes lower in the space 5. However, this does not happen because falling pressure causes the bladder 8 to expand. Outer air flows into the inner space of the bladder 8 through the pipe 6 and the branch pipe 7. It decreases the volume of the inner space 5 of the body 1.

As a result, pressure in the inner space 5 go equal to atmospheric pressure, and dusty air would not penetrate into the inner space 5 of the device body.

Therefore, pressure in the inner space 5 of the device is always equal to atmosphere pressure.

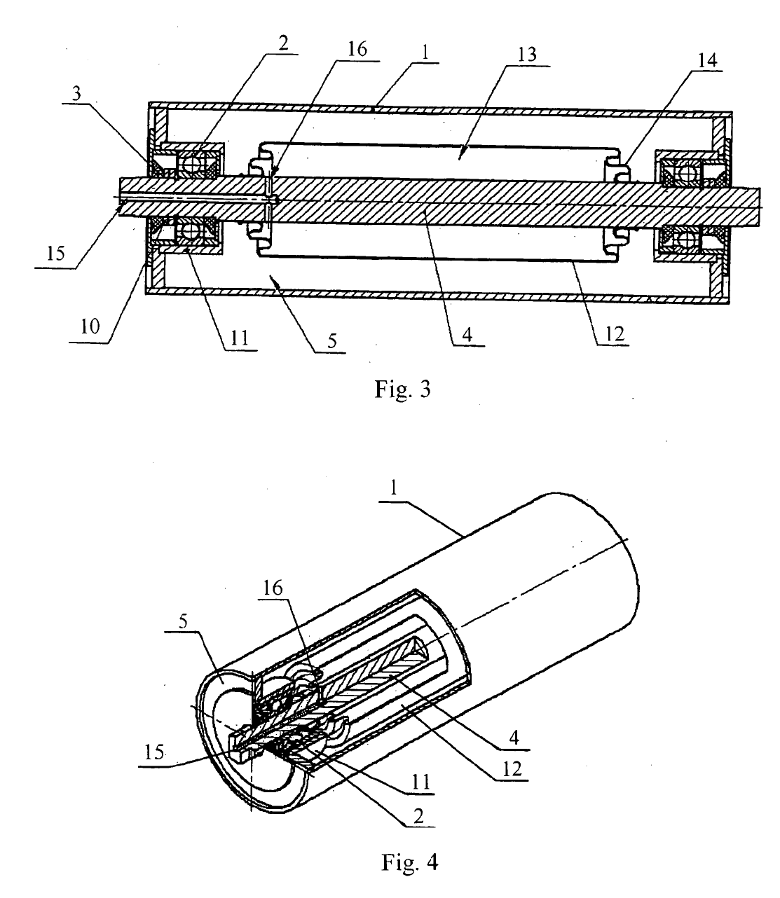

As a practical variant (FIG. 3 and FIG. 4) the rotation unit is made as a cylindric tube body 1 with ring-type empty internal space 5.

The tube body 1 is assembled on shaft 4 with radial bearings 2. The bearings 2 are equipped with labyrinth sealings 3 and support rings 10 fixed in a cylinder 11.

A flexible rubber sleeve 12 is fixed around the shaft 4 forming an inner space 13 between the inner surface of the sleeve 12 and outer surface of the shaft 4. The edges of the sleeve 12 are fixed on the shaft 4 hermetically forming annular folds to insure flexibility of the construction.

Two connected inner channels 15 and 16 are made inside the shaft 4. They connect the inner space of the sleeve 12 with outer atmosphere.

If the temperature of the rotation unit grows, the air goes outside from inner space 13 through channels 15 and 16. This happens because the sleeve 12 is flexible. The air resistance of bearing sealings is higher than the resistance of the sleeve 12 to pressure.

Thus, a dusty air does not go through bearings 2. This improves the resource of the bearings and the service time of the rotation unit.

The design of the claimed device eliminates the cause of dust entering the internal space. Therefore the wear of the components decrease and the service life of the device extends.

What is claimed is:

1. A rotation unit comprising a body mounted in bearings on a shaft to form an inner space between the internal surface of the body and the external surface of the shaft, wherein the rotation unit is provided with a flexible bladder deformable under the effect of difference of pressures, said bladder being installed within said inner space and communicating with the atmosphere.

2. The rotation unit as claimed in claim 1, wherein said bladder is connected with the atmosphere through a channel made in the shaft.

3. The rotation unit as claimed in claim 1, wherein said rotation unit is provided with a perforated box in which said bladder is located.

4. The rotation unit as claimed in claim 1, wherein the flexible bladder has the form of a sleeve embracing the shaft so that the two opposite edges thereof are fixed hermetically on said shaft.

5. The rotation unit as claimed in claim 4, wherein the edges of the sleeve fixed on the spindle have annular folds.
